(19) United States
(12) Patent Application Publication
(10) Pub. No.: US 2014/0113155 A1
(43) Pub. Date: Apr. 24, 2014

(54) WINDOW PROFILE PROVIDED WITH SKIN LAYER HAVING WOOD FIBER

(71) Applicant: LG HAUSYS, LTD., Seoul (KR)

(72) Inventor: Seong Joong Kim, Cheongju-si (KR)

(73) Assignee: LG HAUSYS, LTD., Seoul (KR)

(21) Appl. No.: 14/119,261

(22) PCT Filed: Mar. 13, 2012
(86) PCT No.: PCT/KR2012/001819

§ 371 Date: Nov. 21, 2013

(30) Foreign Application Priority Data
Jun. 17, 2011 (KR) 10-2011-0058795

(51) Int. Cl. B32B 27/20; B29C 47/04; B32B 27/30

(52) U.S. Cl. CPC B32B 27/20; B32B 27/304; B29C 47/046
USPC 428/522; 428/537.1

(57) ABSTRACT

Disclosed is a window profile provided with a skin layer which a co-extrusion resin composition is dual-extruded on one surface of a profile extruded from a main extruder, wherein the co-extrusion resin composition contains wood fiber. The co-extrusion resin composition comprises a first raw material for forming a base color, a second raw material for forming a mid-tone color, and a third raw material for forming a high-tone color. According to the present invention as described above, the skin layer is integrally formed with one side of the profile by the co-extrusion, and thus it is possible to provide the texture of natural wood and thus a luxurious atmosphere. Further, in the window profile, various colors can be naturally expressed on the skin layer of the window profile so as to be distinguished from each other, the embo-patterns are formed into two steps, the repetition period of the patterns becomes long and the like, and thus it is possible to provide the graphicness similar to natural wood.

### TECHNICAL FIELD

The present invention relates to a method of manufacturing a window profile having the texture of natural wood using a co-extrusion technology and a window profile manufactured by the method, and particularly to a window profile that a resin composition containing wood fiber is dual-extruded on one side thereof and embossing is provided thereon, thereby providing patterns having the texture of natural wood.

### BACKGROUND ART

In an extrusion process for manufacturing a conventional window profile, as shown in FIG. 1, if a pellet or compound type material of a thermoplastic resin is injected into an extruder 1 through a hopper 2, the material is heated by a heater disposed in a heating cylinder of the extruder 1 so as to be melted into a gel state, transferred by rotation of an extrusion screw, and then extruded through a die 3 disposed at a front end of the extruder 1. And the melted resin which is extruded through the die 3 so as to have a desired shape is passed through a calibrator and a cooling device 5.

The calibrator 4 allows the profile P passed through the die 3 to maintain its external appearance and have precise dimensions and shapes. Therefore, it is preferable that the calibrator 4 is disposed to be adjacent to the die 3 so that the profile passed through the die 3 can be entered into the calibrator 4 without deformation of its shape. A product passed through the calibrator 4 is cooled by the cooling device 5, drawn by predetermined force through a haul-off device 6 and then cut into a desired size by a cutting device. Thus, the window profile product is completed preliminarily.

And in order to provide various textures and patterns on an upper or side surface of the window profile, which is exposed to an outside upon the construction, a decoration film (sheet) formed of a synthetic resin is attached thereon so as to provide the texture of wood, thereby improving a sense of beauty in the window profile.

However, in order to attach the separate film or sheet to the extruded window profile, it is necessary that the extruded window profile has to be transferred to a separate plate in which a wrapping apparatus is provided, loaded therein and then treated by a separate process. Therefore, it is disadvantage in the aspects of production efficiency and cost, and also when scratches are generated thereon upon the transferring, processing and constructing of it, it is difficult to repair the scratches. Further, since an adhesive is used in the wrapping process, it is not good for user or worker's health.

To overcome the problems, there had been proposed a dual extrusion (co-extrusion) method in which the window profile is dual-extruded. In the dual extrusion, as described above, the profile is extruded by using the extruder so as to have a desired shape, and then other raw material such as PVC is additionally extruded on one side of the profile using an auxiliary extruder.

Even in this case, however, there are some disadvantages and problems in that an outer appearance of the profile on which PVC or the like is applied is unnatural and the appearance thereof is deteriorated due to discoloration of the profile surface formed of the PVC pigment.

And in order to enhance the graphicness of the profile surface, an embo-roll (not shown) was disposed between the die 3 and the calibrator 4 so as to form patterns of an embo-roll surface on the surface of the profile. However, as described above, since the calibrator 4 has to be located to be adjacent to the die, there was limitation in a diameter and a circumferential length of the embo-roll disposed therebetween. As a result, a repetition period of the patterns which are repeatedly formed on the surface of the profile becomes short, and thus the graphicness thereof is deteriorated.

### DISCLOSURE OF INVENTION

### Technical Problem

An object of the present invention is to provide a window profile which can provide the texture of natural wood and thus a luxurious atmosphere. To this end, the present invention provides a profile that a resin composition containing wood fiber is dual-extruded on one side thereof, and an apparatus for manufacturing the same.

### Solution to Problem

To achieve the object of the present invention, the present invention provides a window profile provided with a skin layer which a co-extrusion resin composition is dual-extruded on one surface of a profile extruded from a main extruder, wherein the co-extrusion resin composition contains wood fiber.

Preferably, the co-extrusion resin composition comprises a first raw material for forming a base color, a second raw material for forming a mid-tone color, and a third raw material for forming a high-tone color. The first raw material is composed of PVC, coal stone, wood fiber, an inorganic pigment having weather resistance, and a weather resistant additive, wherein the wood fiber is 15-20%. The second second raw material is composed of one or more of highly polymerized PVC, ASA, PMMA and PE an inorganic mid-tone pigment, and the third raw material is composed of one or more of highly polymerized PVC, ASA, PMMA and PE an inorganic high-tone pigment.

Preferably, a melting point of the first raw material is 160 to 165° C., melting points of the second and third raw materials are 175 to 185° C., and the melting point of the first raw material is lower than those of the second and third raw materials. And each color of the second and third raw materials can be distinguished from each other on the first raw material as the base material due to different among the melting points of the first, second and third raw materials.

Preferably, the the co-extrusion resin compositions further comprises anion powder or air freshener.

### Advantageous Effects of Invention

According to the present invention as described above, the skin layer is integrally formed with one side of the profile by the co-extrusion, and thus it is possible to provide the texture of natural wood and thus a luxurious atmosphere. Further, in the window profile, various colors can be naturally expressed on the skin layer of the window profile so as to be distinguished from each other, the embo-patterns are formed into two steps, the repetition period of the patterns becomes long and the like, and thus it is possible to provide the graphicness similar to natural wood.

### BRIEF DESCRIPTION OF DRAWINGS

The above and other objects, features and advantages of the present invention will become apparent from the following description of preferred embodiments given in conjunction with the accompany drawings, in which:

FIG. 1 is a schematic view of an apparatus for manufacturing a conventional window profile.

FIG. 2 is a schematic view of an apparatus for manufacturing a window profile according to an embodiment of the present invention.

FIG. 3 is a perspective view showing an extrusion method using an extruder and an auxiliary extruder according to the present invention.

FIG. 4 is a cross-sectional view of a profile manufactured from the apparatus according to the present invention.

FIG. 5 is a perspective view of an embo-roll according to the present invention.

FIG. 6 is a cross-sectional view of the embo-roll and an enlarged view of a surface of the embo-roll according to the present invention.

FIG. 7 is a cross-sectional view of a conventional embo-roll and an enlarged view of a surface of the conventional embo-roll.

FIG. 8 is a view of a co-extrusion apparatus for manufacturing the window profile according to the present invention, which is seen in a different direction from FIG. 2.

FIG. 9 is a cross-sectional view of a die and an embo-roll of FIG. 8.

FIG. 10 is a perspective view of a disk of a cooling device in the co-extrusion apparatus according to the present invention.

FIG. 11 is a cross-sectional view of a connector of an auxiliary extruder in the co-extrusion apparatus according to the present invention.

FIG. 12 is a cross-sectional view of a conventional connector.

FIG. 13 is a view of a comparative example showing that patterns are formed on the profile by the co-extrusion apparatus.

FIG. 14 is a view showing that patterns are formed on the profile by the co-extrusion apparatus according to the present invention.

FIG. 15 is a view of an actual product manufactured by using the co-extrusion apparatus according to the present invention.

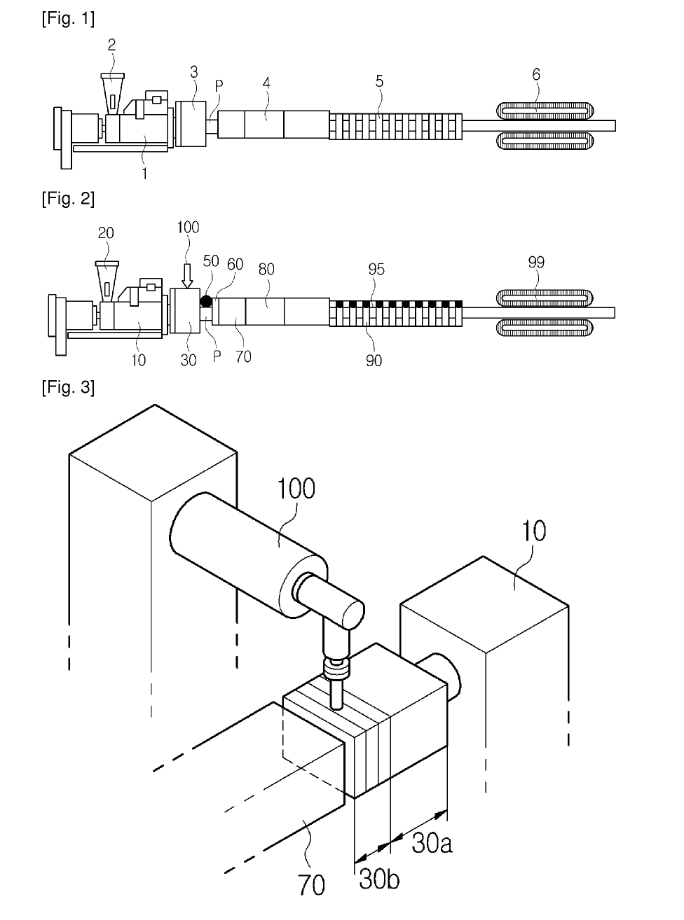

### BEST MODE FOR CARRYING OUT THE INVENTION

Hereinafter, the embodiments of the present invention will be described in detail.

FIG. 2 is a schematic view of an apparatus for manufacturing a window profile according to an embodiment of the present invention. Referring to FIG. 2, if a pellet or compound type material of a thermoplastic resin such as polystyrene (PS), polyethylene (PE), polypropylene (PS), polyvinylchloride (PVC) and a ABS resin is injected into a main extruder 10 through a hopper 20, the material is heated by a heater disposed in the main extruder 10 so as to be melted into a gel state and transferred by rotation of an extrusion screw. After that, a profile P having a desired shape is extruded through a die 30 disposed at a front side of the main extruder 10, and passed through a calibrator 70, 80 and a cooling device 90, and then a haul-off device 99 and a cutter which are similar to the prior art and thus of which the detailed description will be omitted.

Preferably, the calibrator 70 is disposed to be adjacent to the die so that the profile passed through the die can be entered into the calibrator 70 without deformation of its shape, and a surface cooling process of the profile P is performed before the profile P is entered into the calibrator 70. If the profile P is immediately entered into the calibrator without the surface cooling thereof, there may be a problem that embo-patterns formed on a surface of the profile is worn and disappear by surface friction between the molded resin of the profile and an internal metal of the calibrator. Therefore, it is preferable that air is used as a cooling medium. That is, in the surface cooling device, air is uniformly injected on the profile so that the surface of the profile is rapidly cooled.

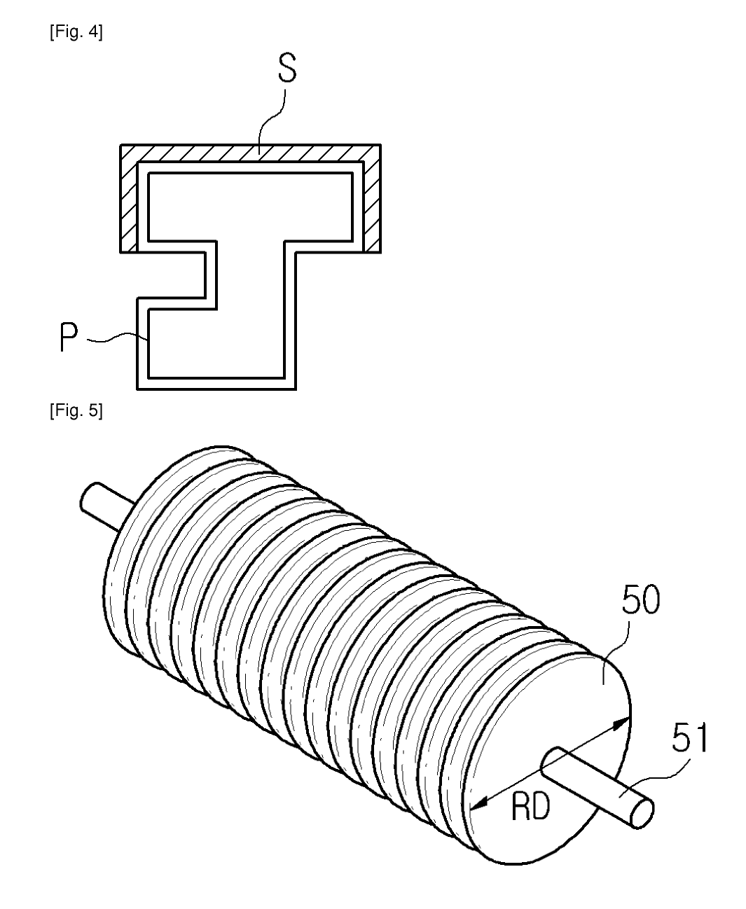

The co-extrusion apparatus of the present invention further includes an auxiliary extruder 100 for a co-extrusion process. FIG. 3 shows a die 30 and an auxiliary extruder 100 according to the present invention. The die 30 includes a main extrusion die 30a and a co-extrusion die 30b. The main extrusion die 30a functions to extrude the resin, which is injected through the hopper 20 and melted into the gel state, so as to have a predetermined shape. The co-extrusion die 30b is disposed at a front side of the main extrusion die 30a functions to form a skin layer (referring to S of FIG. 4) on one side of the profile passed through the main extrusion die 30a. To this end, a co-extrusion resin supplied from the auxiliary extruder 100 is injected into an upper portion of the co-extrusion die 30b. In other words, the co-extrusion resin supplied from the auxiliary extruder 100 is attached on the side of the profile passed through the main extrusion die 30a so as to form the skin layer S and then passed through the co-extrusion die 30b.

FIG. 4 is a cross-sectional view of the profile manufactured by the co-extrusion according to the present invention. The skin layer S is integrally formed with the surface of the window profile P through the co-extrusion. The drawing shows that the skin layer is formed on an upper surface and both sides of the profile. However, the present invention is not limited to the formation of the skin layer. If necessary, the skin layer may be formed on part of the upper surface or whole surfaces of the profile.

By forming the skin layer using the co-extrusion, it is possible to provide various colors using various materials for the skin layer. Since a different material from that of the profile is integrally formed with the profile through the co-extrusion, a post process like attaching of a sheet is not needed after production of the profile. Also, it is possible to reduce manufacturing cost and also enhance workability of the product. Further, since an adhesive is not used, it is environmentally friendly, and also it is advantageous against scratches.

According to the present invention, the co-extrusion resin composition forming the skin layer S contains wood fiber, thereby improving the texture of natural wood and thus graphicness thereof.

The co-extrusion resin composition includes a first raw material for forming a base color, a second raw material for forming a mid-tone color, and a third raw material for forming a high-tone color.

In the present invention, the first raw material as a base material is characterized by containing the wood fiber so that the skin layer of the profile have the texture of natural wood. The first raw material is composed of PVC of 70%, coal stone of 10 to 15%, wood fiber of 15 to 20%, a small amount of inorganic pigment having excellent weather resistance, a small amount of a weather resistant additive and the like.

The second second raw material for forming a mid-tone color is composed of a resin such highly polymerized PVC, ASA, PMMA and PE which has a higher melting point than the first raw material (base material), a small amount of inorganic mid-tone pigment having excellent weather resistance, a small amount of an additive such as a lubricant, and the like.

The third raw material for forming a high-tone color is composed of a resin such highly polymerized PVC, ASA, PMMA and PE which has a higher melting point than the first raw material (base material), a small amount of inorganic high-tone pigment having excellent weather resistance, a small amount of an additive such as a lubricant, and the like.

According to the present invention, the first, second and third raw materials are not mixed in order to form one color. But in a state that the skin layer is formed on the profile, the second and third raw materials respectively show a mid tone color and a high tone color on the first raw material as the base material so that each color can be distinguished from each other, thereby providing natural colors having excellent graphicness.

In order for the colors of the resin compositions to be distinguished from each other, the first raw material has a melting point of about 160 to 165° C., the second raw material has a melting point of about 175 to 185° C., and the third raw material has a melting point of about 175 to 185° C.

The auxiliary extruder 100 functions to heat the co-extrusion resin compositions and then pressurize them toward the co-extrusion die 30b. If the melting points of the resin compositions are all the same, all of the resin compositions are melted and mixed together in the auxiliary extruder 100, and thus each of the colors is not distinguished from each other but changed into one color. Therefore, to prevent such phenomenon, each melting point is different from each other. In other words, when an intern portion of the auxiliary extruder 100 is heated to about 160 to 180° C., the base material having the lowest melting point is firstly melted into a gel state, and the second and third raw materials are partially melted and then discharged to the co-extrusion die. In this process, the second raw material having the mid tone color and the third raw material having the high tone color form natural patterns on the base material.

Further, the co-extrusion resin compositions may further include anion powder, air freshener or the like so as to emit anions into a room, thereby providing a forest-like environment or emitting natural fragrance like phytoncide smell.

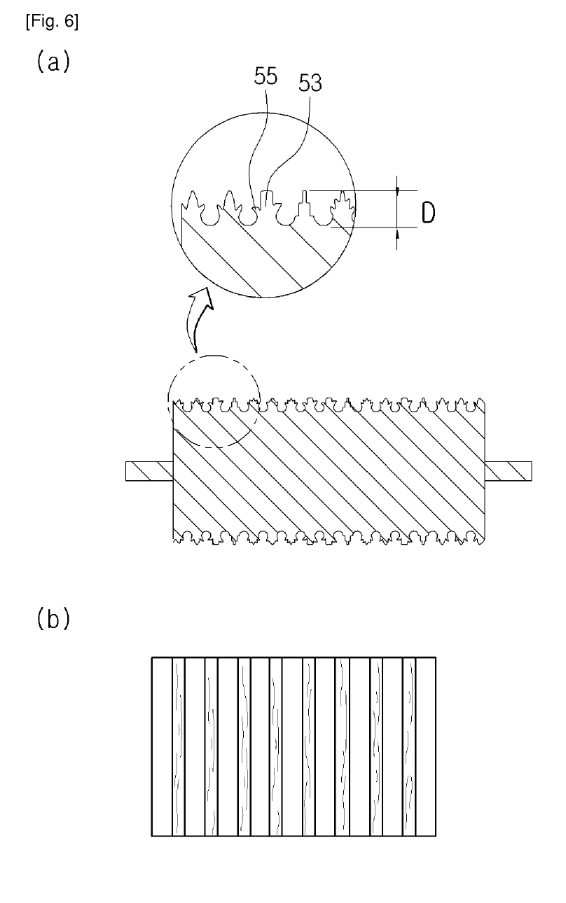

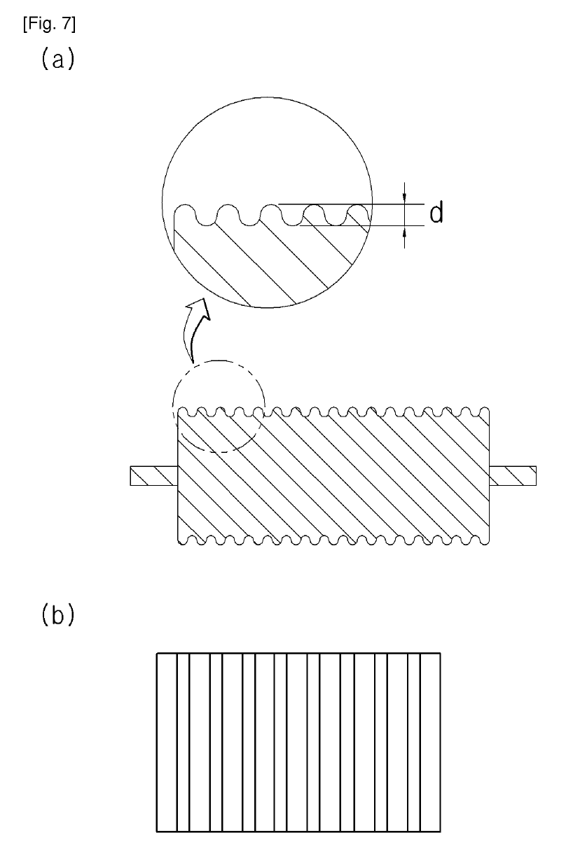

FIG. 5 is a perspective view of an embo-roll 50 according to the present invention, and FIGS. 6a and 6b are a cross-sectional view and an enlarged view of the embo-roll 50 according to the present invention.

The embo-roll 50 of the present invention has a larger diameter than a conventional embo-roll, and patterns are formed into two steps so as to provide excellent continuity of patterns, thereby enhancing graphicness of the appearance and a sense of dimension. The embo-roll 50 is rotatably installed at a rotational shaft 51 and uneven patterns are formed on the surface thereof. That is, as shown in FIG. 6a, the two-stepped uneven patterns are formed on the surface of the embo-roll 50. In other words, the embo-roll 50 includes a first protrusion 53 which is formed to be relatively larger, and a second protrusion 55 which is formed to be relatively smaller on the first protrusion 53. The first and second protrusions 53 and 55 are not a uniform and formal shape but a random shape (the conventional embo-roll shown in FIGS. 7a and 7b has simple patterns which are simply arranged in a uniform depth, and thus its graphicness is deteriorated). A depth D of the first protrusion 53 is formed to be deeper than that d of a protrusion formed on the conventional embo-roll, thereby increasing the graphicness of patterns.

The embo-roll 50 of the present invention has a large diameter RD as well as the large protrusion. If the diameter of the embo-roll is increased, a circumferential length of the embo-roll surface is also increased, and also a length of the embossing pattern formed along the surface of the profile becomes long. Thus, a repetition period of the patterns formed on the profile becomes short, thereby enhancing the graphicness of the patterns.

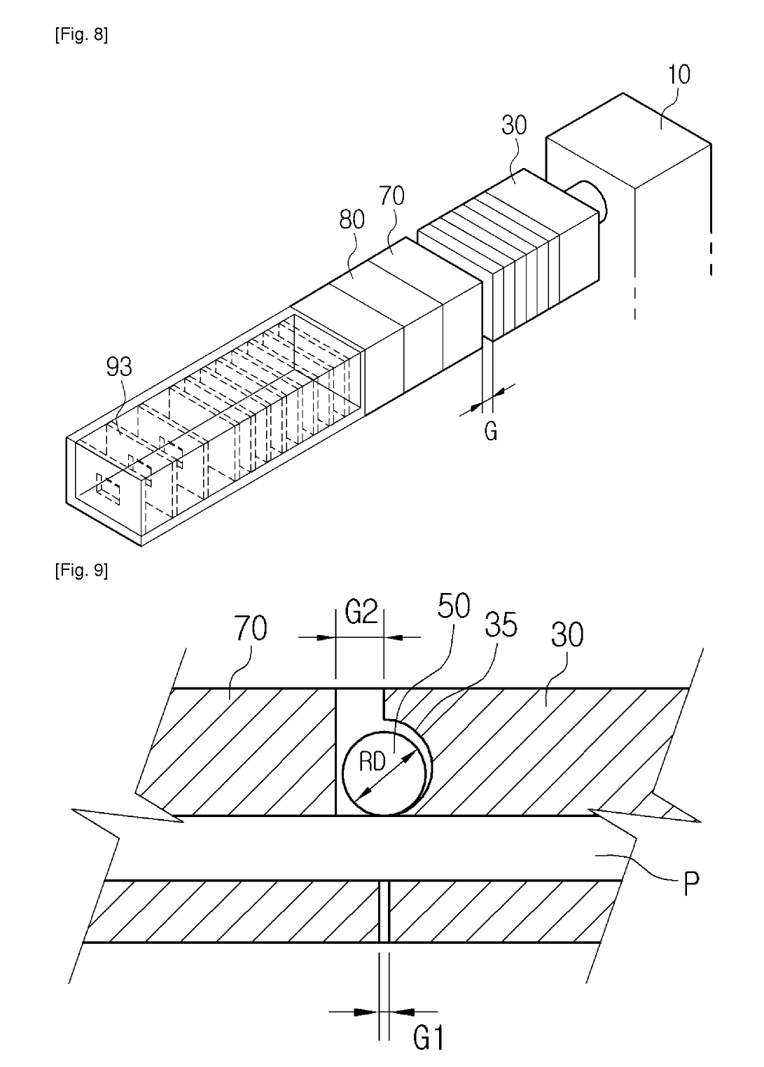

However, the diameter of the embo-roll 50 disposed between the die 30 and the calibrator 70 is restricted due to the limitation of a space between the die 30 and the calibrator 70 as described above. To solve the problem, the present invention proposes a new shape as shown in FIGS. 8 and 9.

FIG. 8 shows part of a co-extrusion apparatus for manufacturing the window profile according to the present invention, which is seen in a different direction from FIG. 2, wherein the auxiliary extruder is omitted, and FIG. 9 is a cross-sectional view of the die 30 and the embo-roll 50 of FIG. 8.

Referring to FIGS. 8 and 9, in the space G between the die 30 and the calibrator 70, a lower space G1 is relatively small but an upper space G2 is relatively large in order to install the embo-roll 50. And a surface of the die 30, on which the embo-roll 50 is disposed, is rounded to have a recessed portion 35, and thus it is possible to provide a sufficient space in which the emobo-roll 50 having the large diameter can be installed. That is, the curved portion 35 corresponding to an external circumference of the embo-roll 50 is formed at the surface of the die 30, to which the profile P is discharged. Therefore, even through the diameter RD of the embo-roll 50 becomes larger than that of the conventional embo-roll, it is possible to install the embo-roll 50 without the excessive increase of the space between the die and the calibrator. Although a semi-circular recessed portion is shown in the drawing, the present invention is not limited to this shape, and if necessary, it is possible to provide various shapes of the recessed portion, e.g., a circular arc shape having a center angle of 90 degrees.

Referring to FIG. 8, the calibrator 70, 80 may include a dry calibrator 70 and a water calibrator 80, or one of them. And in the cooling device 90, a plurality of hollow disks 93 are arranged in a running direction of the profile in a water tank, such that the profile passed through them can be cooled without deformation of the shape of the profile.

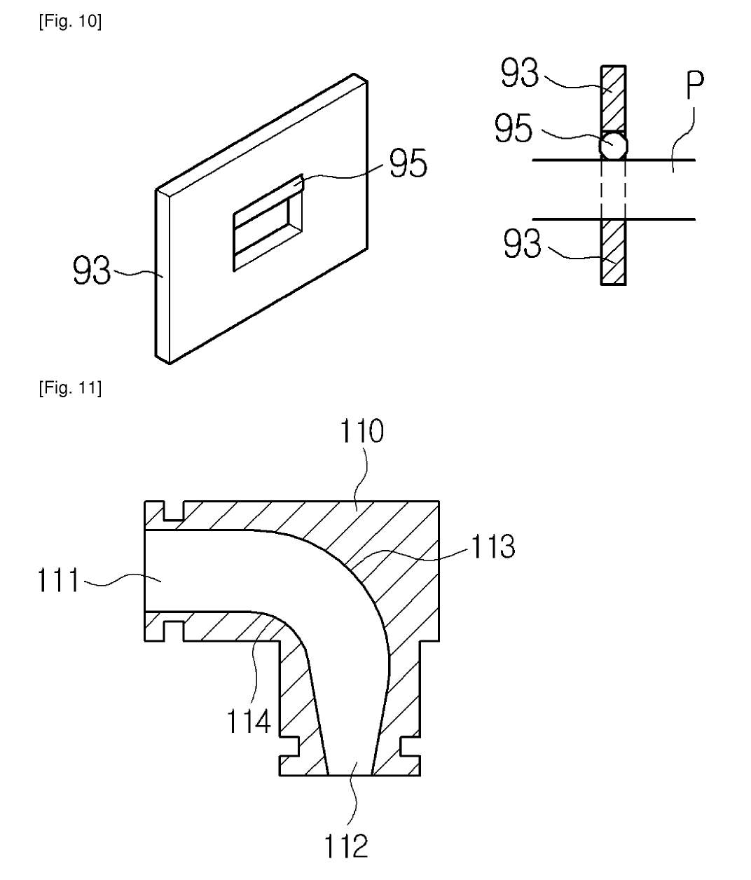

FIG. 10 shows one of the disks of the cooling device 90 according to the present invention. The disk 93 is formed to be hollow at a center portion thereof so that the profile P can be passed therethrough, and a roller 95 is disposed at an upper portion of the hollow portion of the disk 93. A rotational shaft of the roller 95 is fixed to an upper portion of the disk 93, and the roller 95 is rotated while being contacted with the profile passed therethrough. The skin layer S is formed on an upper surface of the profile P by the co-extrusion, and the embo-patterns are formed thereon by the embo-roll 50.

In the conventional cooling device, since there is no the roller 95 of the present invention, the upper surface of the hollow portion of the disc is contacted with the profile passed therethrough, and as a result, the embo-patterns formed on the upper surface of the profile may be damaged.

According to the present invention, since the rotatable roller is provided at a proper position of the disk, which is contacted with the upper surface of the profile, the conventional surface contact with the profile is changed into the line contact with it, and thus it is prevented that the embo-patterns formed on the upper surface of the profile is damaged.

In the present invention, as shown in FIG. 3, the skin layer is co-extruded on the upper surface of the profile using the auxiliary extruder 100. And the auxiliary extruder 100 having an improved passage can be provided by improving a conventional auxiliary extruder which is used to co-extrude PVC or other materials in a conventional manufacturing apparatus.

In the auxiliary extruder 100 of the present invention, the co-extrusion resin composition is pressurized with a predetermined and constant pressure and supplied to the upper portion of the co-extrusion die 30b, such that the skin layer S is formed on the surface of the profile P. As shown in the drawing, the co-extrusion resin composition is horizontally transferred, turned to about 90 degrees and then transferred again vertically so as to be introduced into the upper portion of the co-extrusion die 30b. A connector 110 functions to change the moving direction of the co-extrusion resin composition into the vertical direction. FIG. 11 is a cross-sectional view of the connector 110 according to the present invention. The connector 110 is formed with an inlet port 111 through which the co-extrusion resin composition is introduced, an outlet port 112 which is vertically turned from the inlet port 111, and a curved portion 113, 114 which changes a running direction. An internal diameter of the connector 110 becomes narrow from the inlet port 111 toward the outlet port 112 so that a transferring speed and pressure of the resin composition is increased. The curved portion 113, 114 allows the running direction to be smoothly changed from the horizontal direction to the vertical direction.

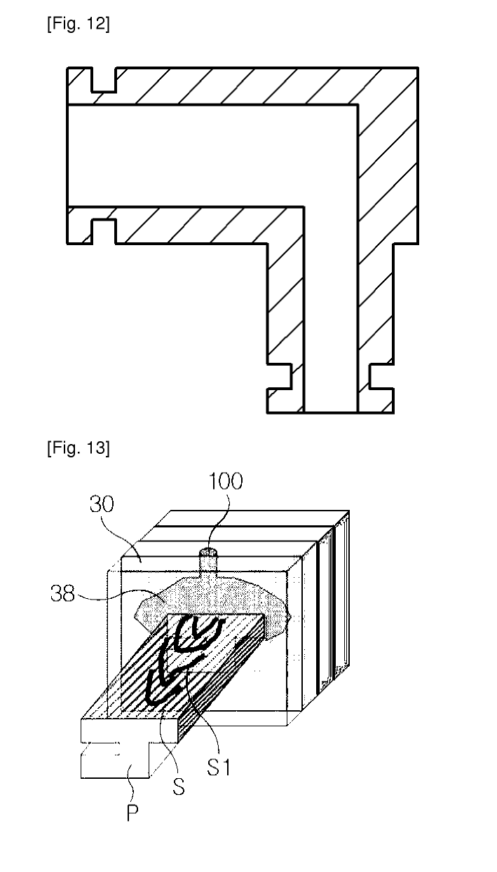

FIG. 12 is a cross-sectional view of a conventional connector. Herein, the running direction of the transferring material is sharply changed from the horizontal direction to the vertical direction. Therefore, the material which is being transferred in the horizontal direction is collided with a vertical wall and thus returned back or accumulated therearound, whereby there is a problem that the transferring pressured is increased. However, since the present invention provides the curved portion, the running direction of the material can be smoothly changed.

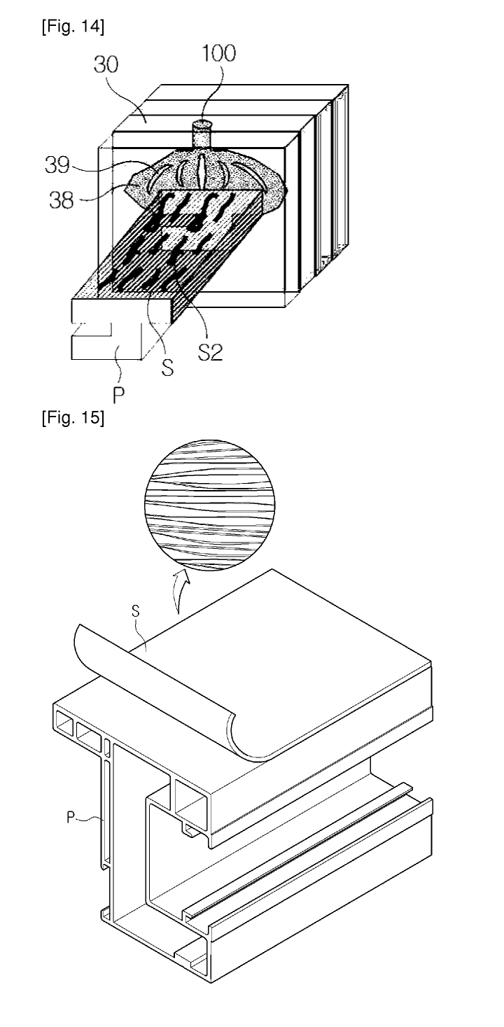

FIG. 13 shows a comparative example showing that patterns are formed on the profile by the co-extrusion apparatus, and FIG. 14 shows that patterns are formed on the profile by the co-extrusion apparatus according to the present invention.

The co-extrusion resin composition is introduced from the auxiliary extruder 100 to the upper portion of the die 30, and then introduced into a co-extrusion pressurizing space 38 formed in the die. Then, the co-extrusion resin composition is applied to the upper surface or the upper and side surfaces of the profile P which is passed through the die and transferred horizontally, thereby forming the skin layer S of the profile. Herein, the second and third raw materials of the resin compositions form the natural patterns.

However, as shown in FIG. 13, if the co-extrusion pressurizing space 38 is formed into a single space, a pressure is concentrically applied to a center portion of the resin composition coated on the profile P, and thus whirlwind patterns S1 are concentrically formed on the center portion of the upper surface of the profile, thereby providing the artificial feeling.

In the present invention, to solve the problem, the co-extrusion pressurizing space 38 is formed into a plurality of compartments. To this end, the present invention provides a passage guide 39 which is formed in the co-extrusion pressurizing space 38 so as to guide the resin composition to separate spaces. Then, the resin composition which is pressurized in the auxiliary extruder 100 and introduced into the co-extrusion pressurizing space 38 of the die is guided to the separate spaces, and thus it is prevent that the resin composition is concentrically applied to the center portion of the upper surface of the profile. Therefore, the pattern S2 formed on the skin layer S of the profile is uniformly formed on the upper surface of the profile, thereby uniformly forming the natural patterns formed into a stripe shape.

As shown in FIG. 14, since the pattern S2 formed on the skin layer S of the profile P manufactured in the co-extrusion apparatus of the present invention is formed by properly distributing the second and third raw materials through the passage guide 39, it has the natural and non-formal patterns and thus the high graphicness.

### INDUSTRIAL APPLICABILITY

According to the present invention, the skin layer is integrally formed with one side of the profile by the co-extrusion, and thus it is possible to provide the texture of natural wood and thus a luxurious atmosphere. Further, in the window profile, various colors can be naturally expressed on the skin layer of the window profile so as to be distinguished from each other, the embo-patterns are formed into two steps, the repetition period of the patterns becomes long and the like, and thus it is possible to provide the graphicness similar to natural wood.

While the present invention has been described with respect to the specific embodiments, it will be apparent to those skilled in the art that various changes and modifications may be made without departing from the spirit and scope of the invention as defined in the following claims.

1. A window profile provided with a skin layer in which a co-extrusion resin composition is dual-extruded on one surface of a profile extruded from a main extruder, wherein the co-extrusion resin composition contains wood fiber.

2. The window profile according to claim 1, wherein the co-extrusion resin composition comprises a first raw material for forming a base color, a second raw material for forming a mid-tone color, and a third raw material for forming a high-tone color.

3. The window profile according to claim 2, wherein the first raw material is composed of PVC, coal stone, wood fiber, an inorganic pigment having weather resistance, and a weather resistant additive and wherein the wood fiber is 15-20%.

4. The window profile according to claim 3, wherein the second second raw material is composed of one or more of highly polymerized PVC, ASA, PMMA and PE an inorganic mid-tone pigment.

5. The window profile according to claim 3, wherein the third raw material is composed of one or more of highly polymerized PVC, ASA, PMMA and PE an inorganic high-tone pigment.

6. The window profile according to claim 3, wherein a melting point of the first raw material is 160 to 165° C., melting points of the second and third raw materials are 175 to 185° C., and the melting point of the first raw material is lower than those of the second and third raw materials.

7. The window profile according to claim 6, wherein each color of the second and third raw materials can be distinguished from each other on the first raw material as the base material due to different among the melting points of the first, second and third raw materials.

8. The window profile according to claim 3, wherein the the co-extrusion resin compositions further comprises anion powder or air freshener.
